(19) United States
(12) Patent Application Publication
(10) Pub. No.: US 2016/0312909 A1
(43) Pub. Date: Oct. 27, 2016

(54) METHOD OF MATCHING VALVE SPOOLS AND BORES

(71) Applicant: GM Global Technology Operations LLC, Detroit, MI (US)

(72) Inventors: Thomas R. Martin, JR., Royal Oak, MI (US); James D. Hendrickson, Oxford, MI (US); Chinar S. Ghike, Farmington Hills, MI (US); Christopher G. Benson, Rochester Hills, MI (US)

(21) Appl. No.: 15/068,074

(22) Filed: Mar. 11, 2016

Related U.S. Application Data
(60) Provisional application No. 62/151,129, filed on Apr. 22, 2015.

(51) Int. Cl. F16K 11/07

(52) U.S. Cl. CPC F16K 11/07

(57) ABSTRACT

A method of selectively matching at least one diameter of a valve spool or piston of a spool valve to at least one diameter of a valve bore in an automatic transmission valve body reduces hydraulic fluid leakage in the valve body. The method includes the steps of fabricating a spool valve having at least one spool or piston, measuring a diameter of the at least one spool or piston and identifying the spool valve as belonging to certain size class, fabricating a valve body having a plurality of machined bores, measuring the diameter of at least one portion of a bore and, based on this measurement, installing a spool valve of the appropriate size class in the bore of the valve body.

### CROSS REFERENCE TO RELATED APPLICATION

This application claims the benefit of U.S. Provisional Patent Application Ser. No. 62/151,129, filed Apr. 22, 2015, which is hereby incorporated in its entirety herein by reference.

### FIELD

The present disclosure relates to a method of matching or select fitting of valve spools and bore diameters and more particularly to a method of matching or select fitting the diameter of a valve spool to the diameter of a bore in an automatic transmission valve body to reduce hydraulic control system leakage in the transmission.

### BACKGROUND

The statements in this section merely provide background information related to the present disclosure and may or may not constitute prior art.

Automatic transmissions for motor vehicles such as passenger cars and light trucks include numerous clutches and brakes that are generally operated by pressurized hydraulic fluid provided to hydraulic operators or actuators. In both multiple planetary and continuously variable transmissions, the fluid application is controlled by a valve body that is typically an integral part of the transmission. The valve body includes myriad passageways and numerous spool valves which direct the hydraulic fluid to the appropriate operator or component, at the appropriate time and in the appropriate sequence.

A certain portion of the pressurized hydraulic fluid that is supplied to the valve body is inevitably lost through leakage as the fluid migrates along and around the spools or pistons of the spool valves from a pressurized region to a lower pressure or unpressurized region. Due to the number of valves in a typical valve body, this leakage can amount to a small but significant volume of fluid. This leakage volume, though small, adversely impacts fuel economy. Reducing such leakage can reduce the pressurized fluid consumption of the transmission and enables the use of a smaller displacement hydraulic pump which has less parasitic loss, thereby improving fuel economy.

The present invention is directed to reducing such fluid leakage in an automatic transmission valve body.

### SUMMARY

The present invention provides a method of selectively matching the diameter of at least one spool or piston of a spool valve to the diameter of the portion of the valve bore in an automatic transmission valve body which receives spool or piston to reduce hydraulic fluid leakage in the valve body. A spool valve which may have several pistons or spools is fabricated, finish ground and the diameter of at least one spool or piston is measured. Typically, a size class will be assigned to each spool valve corresponding to a certain, acceptable range of diameters. The spool valve is physically marked with its designated size class, sorted and inventoried according to its size class. A valve body for an automatic transmission, such as a continuously variable transmission (CVT), is cast and the various valve receiving bores are machined to a final inside diameter. Typically, the diameter of at least one portion of a bore will be measured with an air gauge to determine its exact diameter. A spool valve having the correct (matching) class size is then selected from the inventory and installed in the valve bore. The size class marking on the spool valve will preferably be visible after it is installed in the valve body. Accordingly, the size class can be read and a final check can be made by comparing the size class of the installed spool valve with the size class previously determined and required. If it is the correct spool valve size class, the operation is complete. If the comparison reveals that an incorrect size class of spool valve has been installed, the incorrect spool valve will be removed and the latter steps of the method repeated.

Thus it is an aspect of the present invention to provide a method of selectively matching at least one diameter of a spool valve to at least one diameter of a valve bore in an automatic transmission valve body to reduce hydraulic fluid leakage in the valve body.

It is a further aspect of the present invention to provide a method of selectively matching at least one diameter of a spool valve to at least one diameter of a valve bore in the valve body of a continuously variable transmission.

It is a still further aspect of the present invention to provide a method of selectively matching at least one diameter of a plurality of spool valves to at least one diameter of a plurality of valve bores in an automatic transmission valve body to reduce hydraulic fluid leakage in the valve body.

It is a still further aspect of the present invention to provide a method of selectively matching at least one diameter of a plurality of spool valves to at least one diameter of a plurality of valve bores in the valve body of a continuously variable transmission.

It is a still further aspect of the present invention to provide a method of selectively matching a diameter of a valve spool of a spool valve to a diameter of a valve bore in an automatic transmission valve body by measuring the diameter of the valve spool and classifying the spool valve into one of a plurality of size classes.

It is a still further aspect of the present invention to provide a method of selectively matching a diameter of a valve spool of a spool valve to a diameter of a valve bore in an automatic transmission valve body by measuring the diameter of the valve spool, classifying the spool valve into one of a plurality of size classes and marking the spool valve with the size class.

It is a still further aspect of the present invention to provide a method of selectively matching a diameter of a valve spool to a diameter of a valve bore in an automatic transmission valve body by measuring the inside diameter of the valve bore to determine the appropriate size class of a spool valve to be installed therein.

It is a still further aspect of the present invention to provide a method of selectively matching a diameter of a valve spool to a diameter of a valve bore in an automatic transmission valve body by measuring the inside diameter of the valve bore with an air gauge to determine the appropriate size class of a spool valve to be installed therein.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exploded, perspective view of a typical automatic transmission valve body illustrating the many valve spools and associated components;

FIG. 2 is a full, sectional view of an exemplary valve disposed in the valve body, namely, an actuator feed limit spool valve, illustrating the spool valve, pistons, ports, lands and marking;

FIG. 3 is a flow chart setting forth the several steps of the method according to the present invention which measures a diameter of at least one spool of a spool valve, measures a diameter of at least one bore in a valve body and matches or selectively fits a measured size spool with a measured size bore; and

FIG. 4 is a tabulation presenting the reduction in hydraulic fluid leakage in a valve body for a continuously variable transmission with no matched valve spools and bores, three matched valve spools and bores and six matched valve spools and bores.

### DETAILED DESCRIPTION

The following description is merely exemplary in nature and is not intended to limit the present disclosure, application, or uses.

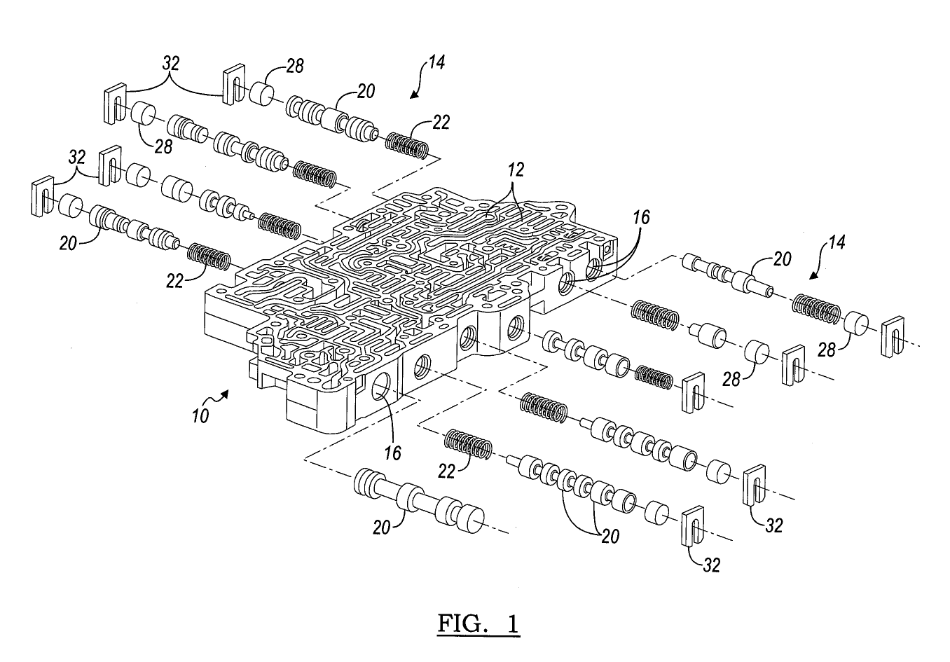

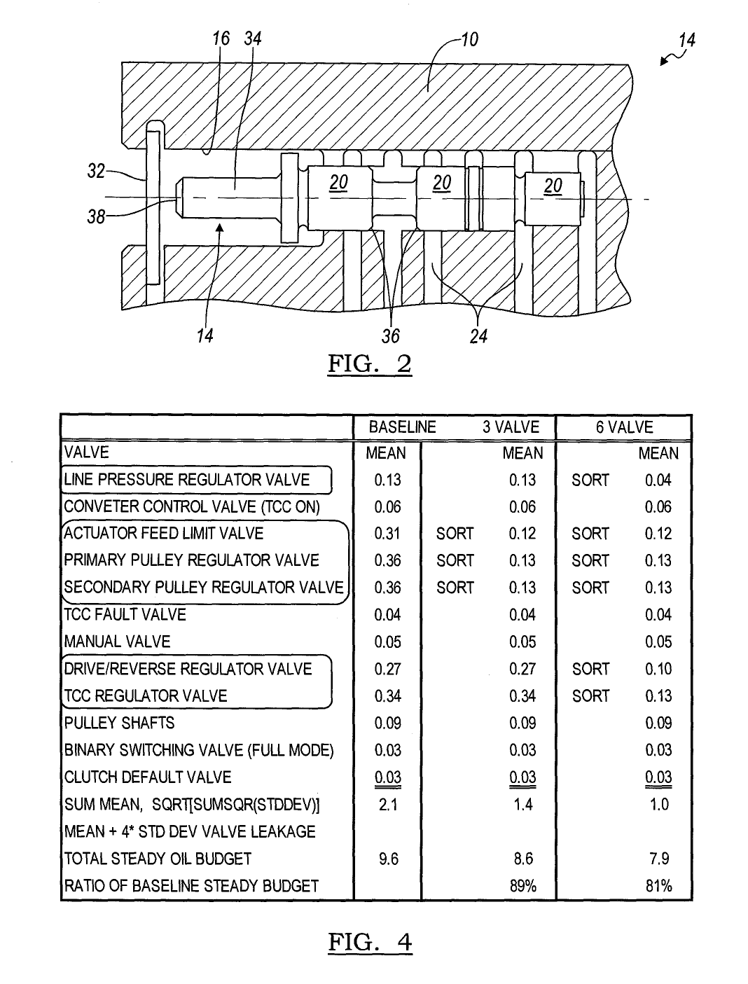

With reference now to FIGS. 1 and 2, a typical and exemplary valve body from an automatic motor vehicle transmission, such as a continuously variable transmission, is illustrated and generally designated by the reference number 10. The valve body 10 includes myriad fluid passageways 12 which provide fluid communication between a plurality of spool valves 14 slidingly disposed in a like plurality of valve bores 16. The spool valves 14 take various forms, define various lengths, include varying numbers of valve spools or pistons 20, may cooperate with biasing springs 22 and provide various functions such as fluid pressure regulation, feedback control and hydraulic actuator operation, for example. Likewise, the valve bores 16 take various forms, define various lengths include various numbers of ports 24 and various numbers of lands 26. Sealing plugs 28 and retainers 32 disposed at the otherwise open ends of the bores 16 seal and retain the spool valves 14 in their respective bores 16. As will become apparent from the following description, a transmission valve body 10 with its numerous spool valves 14 which are subjected to and control high pressure hydraulic fluid in an environment, a motor vehicle, where hydraulic efficiency and thus fuel efficiency is of the greatest concern, is an especially suitable application for the present method.

Referring now particularly to FIG. 2, a typical spool valve 14 is illustrated. The spool valve 14 includes an elongated shank or stem 34 which supports and separates the valve spools or pistons 20. The valve spools or pistons 20 may be of varying diameters and may include regulating notches or chamfers 36 which improve proportioning control. Such regulating notches or chamfers 36 are often associated with spool valves 14 utilized as pressure regulators. The spool valve 14 is disposed in a bore 16 having a plurality of fluid ports 24 which are separated by lands 26 that communicate with other spool valves 14, actuators for pulleys, clutches, brakes and other transmission components (all not illustrated). One end of the bore 16 may be blind and the blind end may function as a reaction surface for a biasing spring 22 (see FIG. 1). The other end of the bore 16 is open during manufacturing to facilitate machining, measurement and assembly of the valve body 10 and the spool valves 14 as will be explained subsequently.

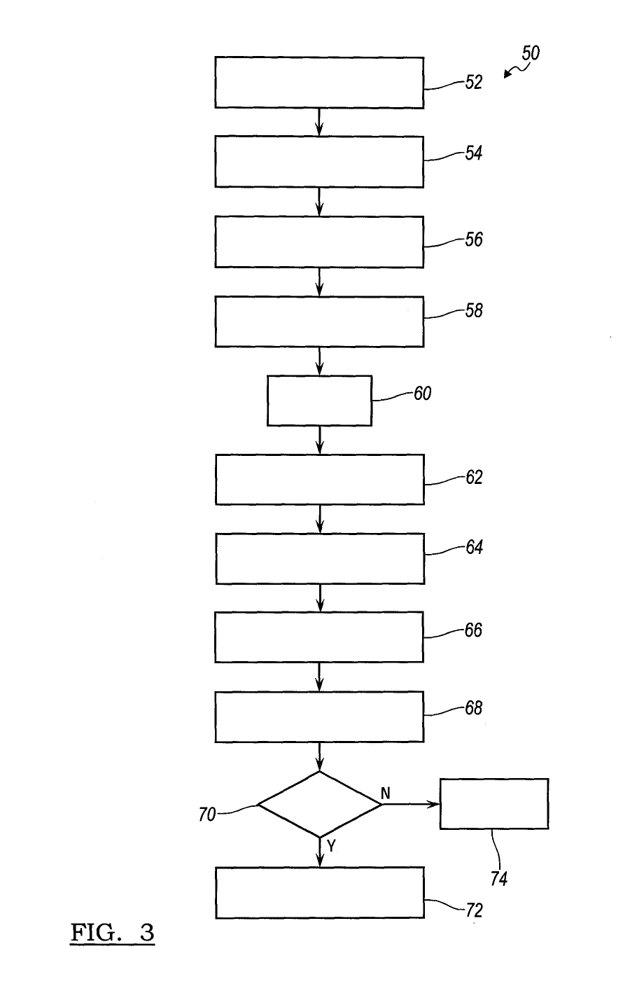

Referring now to FIG. 3, a flow chart setting forth the steps of the inventive method is illustrated and designated by the reference number 50. The method begins with a process step 52 which determines the number of spool valve size classes that will be needed per bore 16 to achieve the desired clearance range. Typically, the number of size classes may be two, three, four or five but in certain situations calling for less leakage and a smaller clearance range five, six or more size classes may be needed. In the next process step 54, the spool valves 14 are manufactured, and after a finish grind, the diameter of a valve spool or piston 20 is measured. The diameter of at least one valve spool or piston 20 is measured on each spool valve 14 but, again, if smaller clearances and reduced leakage are needed, the diameters of two or more spools or pistons 20 may be measured.

Next, a process step 56 sorts the spool valves 14 into designated class sizes. The number of class sizes will vary, again depending upon the desired clearances, but two, three, four or five class sizes have been found suitable in most situations. If smaller clearances are desired, more class sizes may be utilized. Moreover, if multiple valve spools or pistons 20 are measured, classes comprising various combinations of measurements will be established. Once sorted, the spool valves 14 are marked on an end which will be visible when installed in the valve body 10 in a process step 58 with a notation or indicia 38 (illustrated in FIG. 2), which is preferably machine readable indicating the size class of the valve spool 18. In certain spool valves, the visible end of the spool valve defines a recess or re-entrant portion which is configured to receive a spring such as the biasing spring 22 (see FIG. 1). In these cases, a mark, stripe or other indicia 42 may be placed on the shank or stem 34 and be readable through a port 24 of the valve body 10. It will be appreciated that the process steps 56 and 58 just described may be undertaken in the reverse order, if desired.

Next, a process step 60 is performed in which the plurality of bores 16 in the valve body 10 are machined to a final desired diameter and finish. In a process step 62, the inside diameter of a bore 16 is measured in preferably three locations to determine its diameter. The portion of the bore 16 measured is that portion which receives the measured and class sized valve spool or piston 20 of the spool valve 14 in the process step 54, above. Again, if multiple spool and bore matching is occurring, at least a second portion of the bore 16 will be measured. Such measurements are preferably undertaken with an air gauge or similar device that provides a highly accurate readout of diameter. Typically, the bores 16 are classified in 0.008 mm. steps, groups or classes. The bores 16 are preferably measured to 0.010 mm. and gauge repeatability should be on the order of 0.002 mm. or less. In a process step 64, and based upon the indicated diameter of the bore 16, a determination is made as to the correct size class of the spool valve 14, or combination of size classes if multiple spools and bores are being matched. It should also be noted that ideally and preferably, such bore diameter measurement occurs when the valve body 10 is at or near the same temperature at which the diameter of the valve spools or pistons 20 of the spool valve 14 were measured as this further improves the matching of the valve spool or spools 20 and bores 16.

Referring yet to FIG. 3, in a process step 66, and based upon the prior determination, a spool valve 14 of the appropriate size class is selected from inventory and installed in the measured valve bore 16. In a process step 68, a visual inspection of the marked end indicia 38 or shank indicia 42 of the installed spool valve 14 is undertaken, preferably through an automated, machine vision device, to confirm that a spool valve 14 of the proper size class has been installed in the selected bore 16. This is facilitated by, as noted above, marking the appropriate notation or indicia 38 or 42 regarding class size or combination of class sizes on the end of the spool valve 14 or the shank 34 which is exposed or visible when the spool valve 14 is installed in the bore 16, as generally illustrated in FIG. 2. Such notation is preferably any machine readable symbol or symbols or other distinct and recognizable indicia.

The method 50 then moves to a decision point 70. If the correct spool valve 14 size class was installed in the bore 16, the decision point 70 is exited at YES and the method 50 moves on to the next bore 16 in a process step 72 at which time the method 50 is repeated. If the correct spool valve 14 size class was not installed in the bore 16, the decision point 70 is exited at NO and the method 50 moves on to a process step 74 which enters a repair loop to correct the problem.

Referring now to FIG. 4, a tabulation presenting the results of practicing the present invention lists various valve and regulator types of a typical continuously variable automatic transmission. Those six valves and regulators enclosed on boxes, namely, the line pressure regulator valve, the actuator feed limit valve, the primary pulley regulator valve, the secondary pulley regulator valve, the drive/reverse regulator valve and the torque converter clutch regulator valve have been chosen because their operating parameters, such as pressure, fluid flow and operating cycle suggest that both (a) reduced leakage and total leakage will contribute most significantly to overall reduced hydraulic fluid leakage in the valve body 10 and (b) the added cost of undertaking the valve/bore matching of the present invention will have the greatest return, i.e., reduced leakage, per unit cost.

Three additional columns present a mean value for leakage of the numerous valves as a Baseline, when three valves, namely the actuator feed limit valve, the primary pulley regulator valve and the secondary pulley regulator valve have been measured, sorted and utilized according to the present invention and a final column in which six valves, namely, the line pressure regulator valve, the actuator feed limit valve, the primary pulley regulator valve, the secondary pulley regulator valve, the drive/reverse regulator valve and the torque converter clutch regulator have been measured, sorted and utilized according to the present invention. Note that in the Baseline, the total steady state oil (hydraulic fluid) budget (consumption) is 9.6, with three valves sorted and matched according to the present invention, the steady state oil budget is 8.6 which is an 11% reduction from the Baseline. In the last column, with six valves sorted and matched, the steady state oil budget has been further reduced to 7.9 which is a 19% reduction from the Baseline.

The description of the invention is merely exemplary in nature and variations that do not depart from the gist of the invention are intended to be within the scope of the invention. Such variations are not to be regarded as a departure from the spirit and scope of the invention.

What is claimed is:

1. A method of matching valve spools and bores of a transmission valve body, comprising the steps of:
fabricating a plurality of valve spools and measuring an outside diameter of one piston of each of said valve spools,
sorting said valve spools into one of a plurality of classes according to said measured outside diameters,
fabricating a transmission valve body having a plurality of valve bores and measuring an inside diameter of each of said valve bores,
matching one of said valve spools of one of said plurality of classes with one of said bores having a measured inside diameter, and
installing said matching measured valve spool in said measured bore of said valve body.

2. The method of claim 1 further including the step of finish grinding said valve spool after said fabrication step and before said measurement step.

3. The method of claim 1 wherein each of said classes includes said valve spools having a distinct range of measured outside diameters.

4. The method of claim 1 wherein said valve spools of a class of said classes are stored together after said measurement step and before said installation step.

5. The method of claim 1 wherein said measurement of said inside diameter of said valve bores is achieved by an air gauge.

6. The method of claim 1 wherein an indicia corresponding to said measured class is affixed to each said measured valve spool.

7. The method of claim 6 wherein each of said valve spools includes an end and said indicia is affixed to said end.

8. The method of claim 6 wherein said indicia corresponding to one of said plurality of classes is compared to said measured size of said valve bore in which said valve spool is installed.

9. A method of matching valve spools and bores for an automatic transmission valve body, comprising the steps of:
fabricating a plurality of valve spools, finish grinding said valve spools and measuring an outside diameter of each of said valve spools,
sorting said valve spools into a plurality of classes according to their measured outside diameters, each of said classes including a range of measured outside diameters,
fabricating a transmission valve body having a plurality of valve bores and measuring at least one inside diameter of each of said valve bores,
matching one of said valve spools of one of said plurality of classes with one of said bores having a measured inside diameter, and
installing said matching measured valve spool in said measured bore of said valve body.

10. The method of claim 9 wherein said valve spools of each one of said classes are stored together after said measurement step and before said installation step.

11. The method of claim 9 wherein said measurement of said inside diameters of said valve bores is achieved by an air gauge.

12. The method of claim 9 wherein an indicia corresponding to said measured class is disposed on each said measured valve spool.

13. The method of claim 12 wherein each of said valve spools includes an end and said indicia is disposed on said end.

14. A method of matching valve spools and bores in an automatic transmission valve body, comprising the steps of:
fabricating a plurality of valve spools, finish grinding said valve spools and measuring an outside diameter of each of said valve spools,
sorting said valve spools into one of a plurality of classes according to their measured outside diameters, each of said classes including a distinct range of measured outside diameters,
disposing on each said measured valve spool an indicia corresponding to said one of said plurality of classes,
fabricating a transmission valve body having a plurality of machined valve bores and measuring at least one inside diameter of each of said valve bores,
matching one of said valve spools of one of said plurality of classes with one of said bores having a measured inside diameter, and
installing said matching measured valve spool in said measured bore of said valve body.

15. The method of claim 14 wherein valve spools of the same class are stored together after said indicia is disposed on said valve spool and before installation.

16. The method of claim 14 wherein said measurement of said inside diameters of said valve bores is achieved by an air gauge.

17. The method of claim 14 wherein each of said valve spools includes an end and said indicia corresponding to said measured class is disposed on said end of each of said measured valve spools.

18. The method of claim 14 wherein said indicia corresponding to one of said plurality of classes is compared to said measured size of said valve bore in which said valve spool is installed.
